(19) United States
(12) Patent Application Publication
(10) Pub. No.: US 2026/0354481 A1
(43) Pub. Date: Nov. 12, 2026

(54) AEROSOL GENERATING DEVICE

(71) Applicant: KT&G CORPORATION, Daejeon (KR)

(72) Inventors: Jong Sub LEE, Gyeonggi-do (KR); Min Seok JEONG, Seoul (KR); Byung Sung CHO, Gyeonggi-do (KR); Jiatai CHEN, Shenzhen (CN); Shengwen ZHOU, Shenzhen (CN); Qingen KUANG, Shenzhen (CN); Yaping YANG, Shenzhen (CN)

(73) Assignee: KT&G CORPORATION, Daejeon (KR)

(21) Appl. No.: 19/120,014

(22) PCT Filed: Nov. 5, 2024
(86) PCT No.: PCT/KR2024/017260

§ 371 Date: Apr. 10, 2025

(30) Foreign Application Priority Data
Dec. 11, 2023 (CN) 202323384465.5

(51) Int. Cl. A24F 40/48; A24F 40/46; A24F 40/51; H05B 3/02

(52) U.S. Cl. CPC A24F 40/48; A24F 40/46; A24F 40/51; H05B 3/02

(57) ABSTRACT

Provided is an aerosol generating device including a nozzle assembly including an intake chamber arranged therein, a housing assembly in which the nozzle assembly is disposed, the housing assembly including an air inlet, a power mounting chamber, an atomizing chamber and an air inlet chamber, wherein the air inlet is disposed on a side surface of the housing assembly, and communicated with the intake chamber through the air inlet chamber and the atomizing chamber, and the power mounting chamber is spaced apart from the air inlet chamber by a spacer, a heating assembly disposed inside the atomizing chamber, and a power assembly disposed inside the power mounting chamber and configured to supply power to the heating assembly, wherein the power assembly, the heating assembly and the nozzle assembly are sequentially arranged in a linear manner.

### TECHNICAL FIELD

The disclosure relates to the field of atomization technology, and more particularly, to an aerosol generating device.

### BACKGROUND ART

An aerosol generating device, also known as a virtual cigarette, an electronic cigarette, or a vapor cigarette, may be primarily used for smoking cessation or as a replacement for tobacco. The aerosol generating device may heat and atomize a liquid-phase aerosol generating material, and thus, an atomized aerosol generating material may flow out of the aerosol generating device through a nozzle and be provided to a user.

Chinese Utility Model Patent under Publication Number CN219961955U, published on Nov. 7, 2023, discloses a disposable electronic cigarette with a replaceable battery, wherein an outer tube of an electronic cigarette and a cartridge assembly are an inseparable single device, the battery module is inserted into the outer tube and is electrically connected to the cartridge assembly to supply power to a heating wire of the cartridge assembly, an atomizing chamber is disposed inside the cartridge assembly, and an air inlet is disposed at the bottom of the outer tube, such that, during a user's puff process, external airflow flows into the air inlet, sequentially passes through the battery module and the atomizing chamber, and flows into a nozzle.

However, during the operation of such an electronic cigarette, the temperature of the battery module may rise due to heat generation, and as a result, when the airflow passes through the battery module, harmful substances within the battery module may be mixed into the airflow, ultimately causing the harmful substances to move to the nozzle and be inhaled by a user.

### DISCLOSURE OF INVENTION

### Technical Problem

The disclosure provides an aerosol generating device for resolving a technical problem in which hazardous substances within a battery module are mixed into the airflow when the airflow passes through the battery module.

### Solution to Problem

According to embodiment of the disclosure, the following technical solutions are used to solve the technical problem:

According to an embodiment, an aerosol generating device includes a nozzle assembly including an intake chamber arranged therein, a housing assembly in which the nozzle assembly is disposed, the housing assembly including an air inlet, a power mounting chamber, an atomizing chamber and an air inlet chamber, wherein the air inlet is disposed on a side surface of the housing assembly, and communicated with the intake chamber through the air inlet chamber and the atomizing chamber, and the power mounting chamber is spaced apart from the air inlet chamber by a spacer, a heating assembly disposed inside the atomizing chamber, and a power assembly disposed inside the power mounting chamber and configured to supply power to the heating assembly, wherein the power assembly, the heating assembly and the nozzle assembly are sequentially arranged in a linear sequence.

According to some embodiments, the aerosol generating device further includes a microphone assembly, wherein the housing assembly further includes a microphone mounting chamber and a microphone air passage, the microphone mounting chamber is communicated with the power mounting chamber, the air inlet chamber communicates with the microphone mounting chamber through the microphone air passage, and the microphone assembly is mounted in the microphone mounting chamber and separates the microphone air passage from the power mounting chamber.

According to some embodiments, the housing assembly further includes a housing, a first mounting bracket, and a second mounting bracket, the first mounting bracket and the second mounting bracket are sequentially mounted inside the housing in a direction from the housing toward the nozzle assembly, the nozzle assembly is mounted on the second mounting bracket, the air inlet chamber, the microphone mounting chamber, and the microphone air passage are arranged at the first mounting bracket, the air inlet and the power mounting chamber are arranged in the housing, and the atomizing chamber is disposed on the second mounting bracket.

For example, the air inlet chamber penetrates a surface of the first mounting bracket facing the nozzle assembly, the microphone mounting chamber penetrates a surface of the first mounting bracket facing opposite to the nozzle assembly, an airflow induction hole is located in a sidewall of the air inlet chamber, and the air inlet is communicated with the air inlet chamber through the airflow induction hole.

According to some embodiments, the first mounting bracket includes a first protrusion and a second protrusion, the first protrusion and the second protrusion are located inside the air inlet chamber, the first protrusion protrudes against a lower chamber wall of the air inlet chamber, the second protrusion protrudes against a surface of the first protrusion facing the nozzle assembly, the microphone mounting chamber is placed on the first protrusion, the microphone air passage penetrates the second protrusion, and a central axis line of the air inlet is in a common plane with one end surface of the second protrusion, but does not intersect an outer surface of the second protrusion.

According to some embodiments, the housing assembly further includes a fixing plate, the fixing plate fixes electrodes of the heating assembly, the second mounting bracket includes a third protrusion, the third protrusion is positioned inside the air inlet chamber, and an outer surface of the third protrusion is in contact with a chamber sidewall of the air inlet chamber, an accommodation chamber is disposed on a surface of the third projection facing opposite to the nozzle assembly, and the fixing plate is placed inside the accommodation chamber.

For example, a first air induction port is disposed on the fixing plate, a second air induction port is disposed at the second mounting bracket, the first air induction port and the second air induction port are arranged coaxially, and the air inlet chamber is communicated with the atomizing chamber through the first air induction port and the second air induction port.

According to some embodiments, the heating assembly is mounted on a wall of the atomizing chamber opposite the power assembly, the intake chamber is located on one side of the heating assembly, the second air induction port penetrates through the atomizing chamber and faces a wall of the power assembly, and a central axis line of the second air induction port penetrates the heating assembly.

For example, a central axis line of the microphone air passage is parallel to a central axis line of the first air induction port, and the microphone air passage is misaligned with the first air induction port.

According to some embodiments, the second air induction port includes a thick cylindrical air passage and a thin cylindrical air passage which are communicated with each other and arranged coaxially, a cross-sectional diameter of the thick cylindrical air passage is greater than a cross-sectional diameter of the thin cylindrical air passage, and the air inlet chamber is communicated with the atomizing chamber through the first air induction port, the thick cylindrical air passage, and the thin cylindrical air passage.

According to some embodiments, an aerosol generating material storage chamber is disposed in the nozzle assembly, the aerosol generating material storage chamber penetrates the nozzle assembly and is directed toward one end of the power assembly, an aerosol generating material inlet chamber and an aerosol generating material inlet are further arranged on the second mounting bracket, the aerosol generating material inlet chamber penetrates one end of the second mounting bracket opposite to the power assembly, the aerosol generating material storage chamber sequentially passes through the aerosol generating material inlet chamber, and the aerosol generating material inlet and communicates with the atomizing chamber, the aerosol generating material storage chamber, the aerosol generating material inlet chamber, the aerosol generating material inlet, and the atomizing chamber are arranged linearly and sequentially in a direction toward the power assembly, the heating assembly covers the aerosol generating material inlet, and the nozzle assembly is disposed on an outer surface of the second mounting bracket.

Also, a first sealing member is disposed between an outer surface of the nozzle assembly and the second mounting bracket, and the first sealing member seals a gap between the nozzle assembly and the outer surface of the second mounting bracket.

According to some embodiments, the air inlet includes two inlets symmetrically arranged with respect to the central axis line of the housing assembly.

### Advantageous Effects of Invention

An aerosol generating device according to embodiments may prevent harmful substances that may be generated after a power assembly is heated from being transmitted to a user.

### BRIEF DESCRIPTION OF DRAWINGS

One or more embodiments will be exemplarily described herein with reference to images in drawings corresponding thereto, but these illustrative descriptions do not limit the embodiments, elements having the same reference numerals or symbols in the drawings are represented as similar elements, and, unless specifically stated otherwise, the images in the drawings do not constitute a proportional limitation.

FIG. 1 is a 3-dimensional diagram of an aerosol generating device according to an embodiment.

FIG. 2 is a cross-sectional view of the aerosol generating device of FIG. 1.

FIG. 3 is another cross-sectional view of the aerosol generating device of FIG. 1.

FIG. 4 is an exploded view of the aerosol generating device of FIG. 1.

FIG. 5 is a 3-dimensional view of a first mounting bracket of the aerosol generating device of FIG. 1.

FIG. 6 is a cross-sectional view of the first mounting bracket of the aerosol generating device of FIG. 1.

FIG. 7 is a 3-dimensional view of a second mounting bracket and a fixing plate of the aerosol generating device of FIG. 1 when they are connected.

FIG. 8 is a 3-dimensional view of the first mounting bracket, the second mounting bracket, and the fixing plate of the aerosol generating device of FIG. 1 when they are connected.

FIG. 8 is a cross-sectional view of the first mounting bracket, the second mounting bracket, and the nozzle assembly of the aerosol generating device of FIG. 1 when they are connected.

FIG. 10 is a cross-sectional view of the second bracket and the nozzle assembly of the aerosol generating device of FIG. 1 when they are connected.

### BEST MODE FOR CARRYING OUT THE INVENTION MODE FOR THE INVENTION

For convenience of understanding of the disclosure, the disclosure will be described in more detail with reference to the drawings and specific embodiments below. It should be noted that, when an element is described as being “connected” to another element, it may be directly on the other element, or there may be one or more intervening elements present. The directional or positional relationships indicated by the terms “above,” “below,” “left,” “right,” “top,” “bottom,” “top,” and “bottom” used in this specification are based on the directional or positional relationships illustrated in the drawings and are merely for convenience and simplification in describing the disclosure, and do not necessarily indicate that a device or an element indicated needs to have a specific orientation, be configured and operate in a specific orientation, and should not be construed as a limitation to the disclosure. Also, terms such as “first,” “second,” etc. are for descriptive purposes only and should not be construed as indicating or implying relative importance.

Unless defined otherwise, all technical and scientific terms used herein have the same meaning as those commonly understood by one of ordinary skill in the art to which the disclosure belongs. The terms used in the specification of the disclosure are for the purpose of describing specific embodiments only and are not intended to limit the embodiments of the disclosure.

Hereinafter, with reference to the attached drawings of the entire specification, an aerosol generating device 100 according to an embodiment will be described in detail through specific examples.

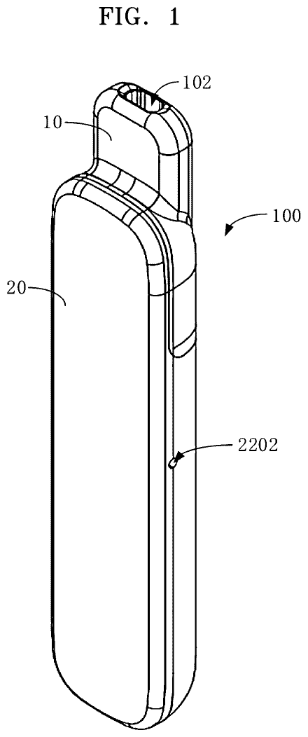

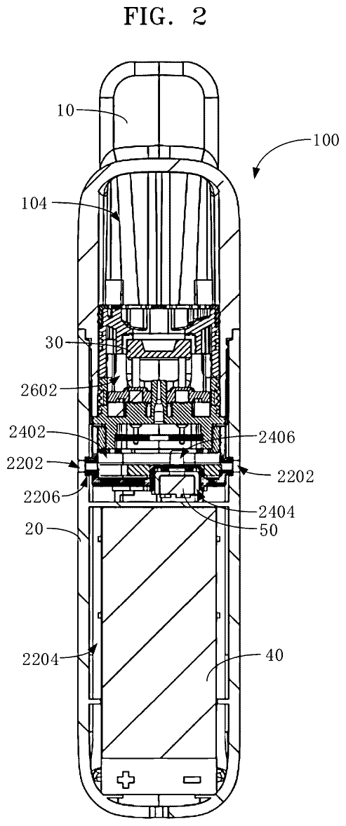

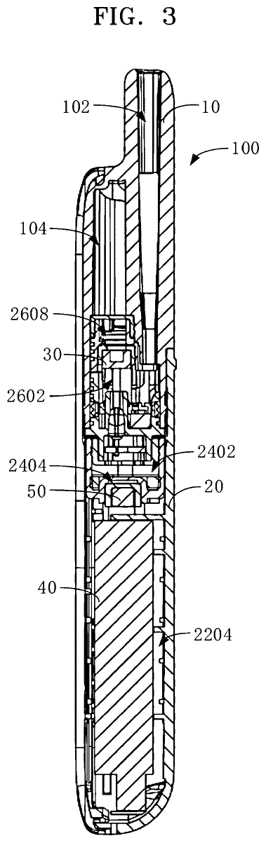

FIG. 1 is a 3-dimensional view of an aerosol generating device according to an embodiment; FIG. 2 is a cross-sectional view of the aerosol generating device of FIG. 1; and FIG. 3 is another cross-sectional view of the aerosol generating device of FIG. 1.

Referring to FIGS. 1, 2 and 3, an aerosol generating device 100 according to an embodiment may include a nozzle assembly 10, a housing assembly 20, a heating assembly 30, and a power assembly 40.

An intake chamber 102 may be disposed inside the nozzle assembly 10, and the nozzle assembly 10 may be mounted on the housing assembly 20.

The housing assembly 20 may include an air inlet 2202, a power mounting chamber 2204, an atomizing chamber 2602, and an air inlet chamber 2402. The air inlet 2202 is positioned on a side surface of the housing assembly 20, the air inlet 2202 is communicated with the intake chamber 102 through the air inlet chamber 2402 and the atomizing chamber 2602 in the order stated, and the power mounting chamber 2204 may be spaced apart from the air inlet chamber 2402.

The heating assembly 30 may be mounted inside the atomizing chamber 2602.

The power assembly 40 is mounted inside the power mounting chamber 2204, and the power assembly 40 may supply power to the heating assembly 30. At this time, the power assembly 40, the heating assembly 30, and the nozzle assembly 10 may be arranged sequentially and linearly.

According to the present embodiment, an aerosol generating material storage chamber 104 is disposed inside the nozzle assembly 10; according to another embodiment, the aerosol generating material storage chamber 104 may be disposed in the housing assembly 20.

Through the above structure, when a user puffs or inhales the aerosol generating device 100 along the nozzle assembly 10, an external gas may sequentially pass through the air inlet 2202 and the air inlet chamber 2402 and move to the atomizing chamber 2602. At this time, the liquid-phase aerosol generating material inside the aerosol generating material storage chamber 104 moves to the atomizing chamber 2602, and the aerosol generating material may be atomized inside the atomizing chamber 2602, thereby generating vapor. The vapor generated from the aerosol generating material is mixed with an external gas, and the mixture of the external gas and the vapor may move to the intake chamber 102 and be provided to the user when the user inhales.

In the above-described process, the power mounting chamber 2204 is separated from the air inlet chamber 2402, and the external gas does not come into contact with the power assembly 40 through the power mounting chamber 2204, and thus harmful substances generated after the power assembly 40 is heated may not be mixed with the external airflow. As a result, in the aerosol generating device 100 of the disclosure, harmful substances generated after the power assembly 40 is heated are not inhaled by the user.

According to the present embodiment, the nozzle assembly 10 may be mounted to the housing assembly 20 in a snap connection manner, and the nozzle assembly 10 may be placed in a sleeve-like form on the outside of the housing assembly 20.

A first sealing member 60 (refer to FIG. 9) is disposed between the nozzle assembly 10 and the housing assembly 20, and the first sealing member 60 may seal a gap between the nozzle assembly 10 and the housing assembly 20.

According to an embodiment, the air inlet 2202 is a circular aperture, and the power mounting chamber 2204 and the atomizing chamber 2602 may be respectively positioned on two sides of the central axis line of the air inlet 2202.

The power assembly 40 may include a battery having a cuboid-like shape, and the power mounting chamber 2204 and the air inlet 2202 may be separated by a spacer, and an electrode of the heating assembly 30 may be disposed to penetrate through the spacer and may be electrically connected to the power assembly 40.

According to another embodiment, the nozzle assembly 10 may be mounted to the housing assembly 20 in another manner, e.g., through soldering, and an aerosol generating material inlet may be disposed on the first sealing member 60.

However, the shapes of the air inlet 2202 and the power assembly 40 are not limited to the above-described embodiment, and, according to embodiments, the air inlet 2202 may have other shapes, such as a hole having a rectangular cross-section or a truncated cone-shaped hole, and the power assembly 40 may have other shapes, such as a cylindrical shape.

According to some embodiments, the aerosol generating device 100 may further include a microphone assembly 50.

The housing assembly 20 may further include a microphone mounting chamber 2404 and a microphone air passage 2406, wherein the microphone mounting chamber 2404 may communicate with the power mounting chamber 2204, and the air inlet chamber 2402 may communicate with the microphone mounting chamber 2404 through the microphone air passage 2406. At this time, the microphone assembly 50 is mounted inside the microphone mounting chamber 2404 and may separate the microphone air passage 2406 and the power mounting chamber 2204.

According to the structure described above, the microphone mounting chamber 2404 is independent from the air inlet chamber 2402, and the air passage within the aerosol generating device 100 is divided into two air passages, wherein one of the air passages (a first air passage) may sequentially pass through the air inlet 2202, the air inlet chamber 2402, the atomizing chamber 2602, and the intake chamber 102. Such an air passage (the first air passage) may serve to mix the external gas and smoke and provide a mixture thereof for inhalation by a user.

The other air passage (a second air passage) may sequentially pass through the air inlet 2202, the microphone air passage 2406, and the microphone mounting chamber 2404. The other air passage (the second air passage) may be utilized by the microphone assembly 50 to induce airflow, and the microphone assembly 50 may control opening and closing of the heating assembly 30.

A gas moving to the microphone mounting chamber 2404 does not pass through the atomizing chamber 2602, and it is difficult for the smoke inside the atomizing chamber 2602 to move into the microphone mounting chamber 2404, and thus the vapor may condense on the microphone assembly 50. The vapor condensed on the microphone assembly 50 may inhibit the formation of an aerosol generating material, and thus the microphone assembly 50 may be damaged.

Also, the power assembly 40 may also supply power to the microphone assembly 50, and, when the microphone mounting chamber 2404 communicates with the power mounting chamber 2204, the microphone assembly 50 may be more easily electrically connected to the power assembly 40.

The microphone assembly 50 separates the microphone air passage 2406 and the power mounting chamber 2204 from each other, such that a gas moving to the microphone mounting chamber 2404 through the microphone air passage 2406 does not come into contact with the power assembly 40, and, even when the gas inside the microphone mounting chamber 2404 flows back into the air inlet chamber 2402, no harmful substances on the surface of the power assembly 40 are carried into the air inlet chamber 2402.

In detail, according to the present embodiment, the microphone mounting chamber 2404 has a cylindrical shape, the microphone air passage 2406 also has a cylindrical shape, and the central axis line of the microphone mounting chamber 2404 may be arranged parallel to a direction from the power mounting chamber 2204 toward the atomizing chamber 2602. The microphone mounting chamber 2404 may be located on one side of the central axis line of the air inlet chamber 2402, the central axis line of the microphone air passage 2406 may be parallel to the central axis line of the microphone mounting chamber 2404, and the central axis line of the microphone air passage 2406 may be perpendicular to the central axis line of the air inlet 2202.

An end of the microphone mounting chamber 2404 facing a side opposite to the microphone air passage 2406 may communicate with the power mounting chamber 2204, the microphone assembly 50 may have a cylindrical shape, a side surface of the microphone assembly 50 and a sidewall of the microphone mounting chamber 2404 may contact each other, and the microphone assembly 50 may separate the microphone air passage 2406 and the power mounting chamber 2204 from each other.

According to another embodiments, the microphone mounting chamber 2404 may have a different shape, e.g.,, a cuboidal shape, and the microphone air passage 2406 may also have a different shape, e.g., a cuboidal shape. At this time, the central axis line of the microphone air passage 2406 may be a common line with the central axis line of the microphone mounting chamber 2404; and the central axis line of the microphone mounting chamber 2404 may be a common line with the central axis line of the air inlet chamber 2402.

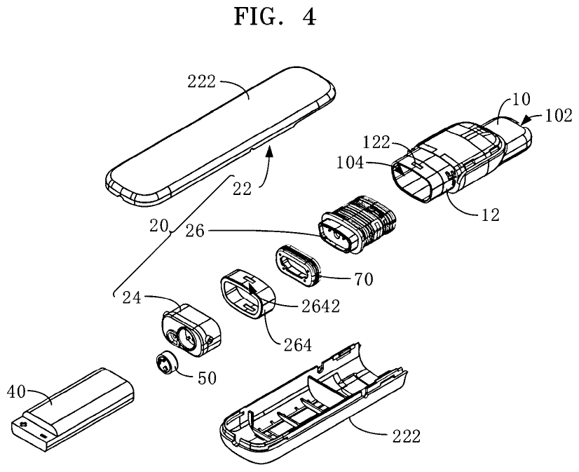

FIG. 4 is an exploded view of the aerosol generating device of FIG. 1.

Referring to FIG. 4, according to some embodiments, the housing assembly 20 may include a housing 22, a first mounting bracket 24, and a second mounting bracket 26.

The first mounting bracket 24 and the second mounting bracket 26 may be sequentially mounted inside the housing 22 in a direction toward the nozzle assembly 10 in the housing 22.

The nozzle assembly 10 may be mounted on the second mounting bracket 26, the air inlet chamber 2402, the microphone mounting chamber 2404 and the microphone air passage 2406 may be arranged on the first mounting bracket 24, the air inlet chamber 2402 and the power mounting chamber 2204 may be arranged on the housing 22, and the atomizing chamber 2602 may be disposed on the second mounting bracket 26.

The air inlet chamber 2402 passes through a surface of the first mounting bracket 24 facing the nozzle assembly 10, the microphone mounting chamber 2404 passes through a surface of the first mounting bracket 24 facing the opposite side of the nozzle assembly 10, an airflow induction hole 2408 is arranged on a sidewall of the air inlet chamber 2402, and the air inlet 2202 communicates with the air inlet chamber 2402 through the airflow induction hole 2408.

Through the structure described above, in the process of assembling the aerosol generating device 100, the power assembly 40 may be first mounted inside the power mounting chamber 2204, the microphone assembly 50 may be mounted inside the microphone mounting chamber 2404, and the first mounting bracket 24 may be mounted inside the housing 22, such that the power mounting chamber 2204 may be separated from the air inlet chamber 2402, and the air inlet 2202 may be communicated with the air inlet chamber 2402.

Also, the nozzle assembly 10 may be mounted on the second mounting bracket 26 to connect the atomizing chamber 2602 with the intake chamber 102, and, finally, after the second mounting bracket 26 is combined with the nozzle assembly 10, the entire structure may be mounted on the housing 22 to connect the air inlet chamber 2402 with the atomizing chamber 2602.

In other words, the aerosol generating device 100 of the disclosure may be assembled in a manner in which the first mounting bracket 24 and the housing 22 are assembled to each other and, at the same time, the nozzle assembly 10 and the second mounting bracket 26 are also assembled to each other. As a result, the assembly speed of the aerosol generating device 100 may be improved.

In detail, the housing 22 includes two sub-housings 222, the two sub-housings 222 are arranged to surround the air inlet 2202 and the power mounting chamber 2204, and the first mounting bracket 24 and the nozzle assembly 10 are inserted into the two sub-housings 222. At this time, after mounting the first mounting bracket 24 and the power assembly 40 to one sub-housing 222, the two sub-housings 222 are assembled to form the housing 22, thereby completing the assembly between the first mounting bracket 24, the housing 22, and the power assembly 40.

According to the present embodiment, a snap groove 2206 (refer to FIG. 2) is arranged on the housing 22, the snap groove 2206 has a cylindrical structure, and the air inlet 2202 may be arranged on the groove wall of the snap groove 2206 and penetrate through the outer surface of the housing 22.

A snap connection post 246 is protrudingly disposed on the outer surface of the first mounting bracket 24, the snap connection post 246 is snap-connected to the interior of the snap groove 2206, the airflow induction hole 2408 is a circular hole, and the airflow induction hole 2408 may penetrate through the snap connection post 246.

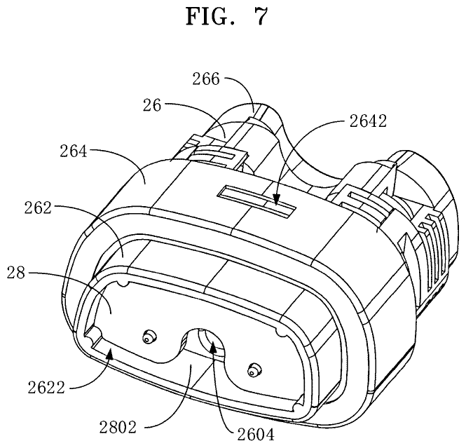

The second mounting bracket 26 includes a snap ring 264, a gap is provided between the inner surface of the snap ring 264 and the sidewall of the atomizing chamber 2602, and a snap connection pass-through groove 2642 (refer to FIG. 7) may be disposed on the snap ring 264.

The nozzle assembly 10 includes an annular wall 12, the annular wall 12 is inserted into the interior of the gap between the inner surface of the snap ring 264 and the sidewall of the atomizing chamber 2602, a snap connection member 122 (refer to FIG. 9) is protrudingly disposed on an outer surface of the annular wall 12, the outer surface of the annular wall 12 is in contact with the inner surface of the snap ring 264, and the snap connection member 122 may be snap-connected with the groove wall of the snap groove 2206. In other words, the second mounting bracket 26 may be snap-connected to the housing 22.

According to another embodiments, the housing 22 and the first mounting bracket 24 may be connected in another manner, e.g., through soldering, the second mounting bracket 26 and the nozzle assembly 10 may also be connected through soldering, and the second mounting bracket 26 and the housing 22 may also be connected in another manner. For example, the second mounting bracket 26 may have a cylindrical structure, and the second mounting bracket 26 may be connected to the housing 22 by screws. However, the connection method is not limited thereto.

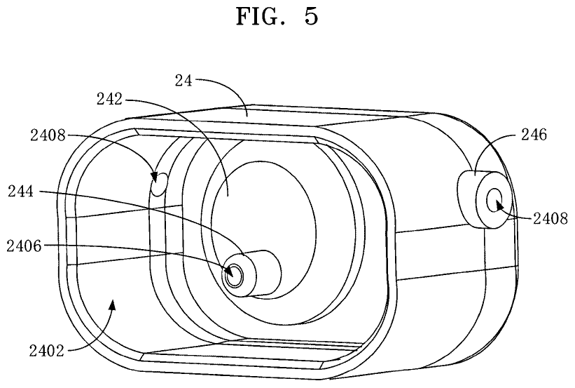

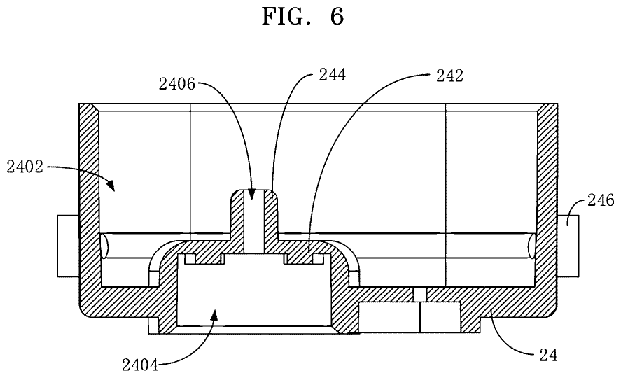

FIG. 5 is a 3-dimensional view of a first mounting bracket of the aerosol generating device of FIG. 1; FIG. 6 is a cross-sectional view of the first mounting bracket of the aerosol generating device of FIG. 1.

Referring to FIGS. 5 and 6, according to some embodiments, the first mounting bracket 24 may include a first protrusion 242 and a second protrusion 244.

The first protrusion 242 and the second protrusion 244 may both be positioned inside the air inlet chamber 2402, the first protrusion 242 may protrude against the lower wall of the air inlet chamber 2402, and the second protrusion 244 may protrude toward the surface of the nozzle assembly 10 with respect to the first protrusion 242.

The microphone mounting chamber 2404 is disposed at the first protrusion 242, the microphone air passage 2406 penetrates through the second protrusion 244; the central axis line of the air inlet 2202 may be disposed in a common plane with one cross-section of the second protrusion 244, but may be disposed to not to intersect with the outer surface of the second protrusion 244.

By the above-described structure, under the action of the first protrusion 242 and the second protrusion 244, a location where the microphone air passage 2406 communicates with the air inlet chamber 2402 may be higher than the lower wall of the air inlet chamber 2402. As a result, when a user stops puffing the aerosol generating device 100 and the smoke inside the atomizing chamber 2602 flows back into the air inlet chamber 2402, the smoke in the air inlet chamber 2402 may also have difficulty moving into the microphone air passage 2406, and the possibility of the smoke coming into contact with the microphone assembly 50 may also be reduced.

In detail, according to the present embodiment, both the first protrusion 242 and the second protrusion 244 have cylindrical structures, wherein the size of the cross-section of the first protrusion 242 may be greater than the size of the cross-section of the second protrusion 244. Also, the first protrusion 242 may be disposed on one side of the central axis line of the second protrusion 244, the central axis line of the first protrusion 242 may be parallel to the central axis line of the second protrusion 244, and the central axis line of the air inlet 2202 may be perpendicular to the central axis line of the first protrusion 242.

According to another embodiments, the first protrusion 242 may have another shape, e.g., a cuboidal shape; and the second protrusion may also have another shape, e.g., a hemispherical shape.

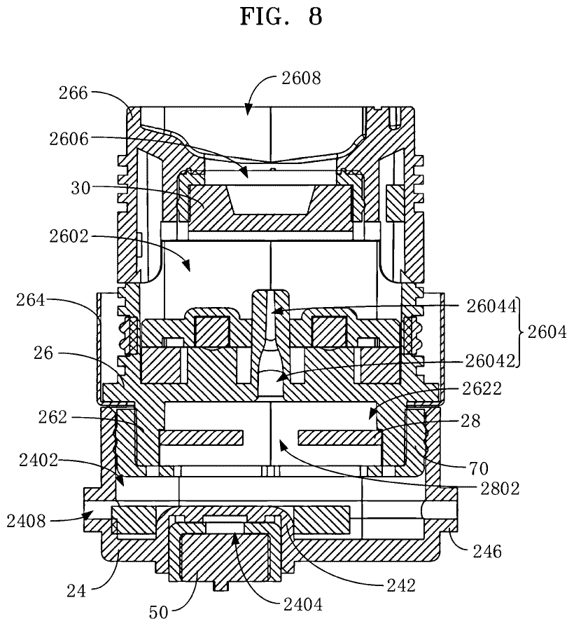

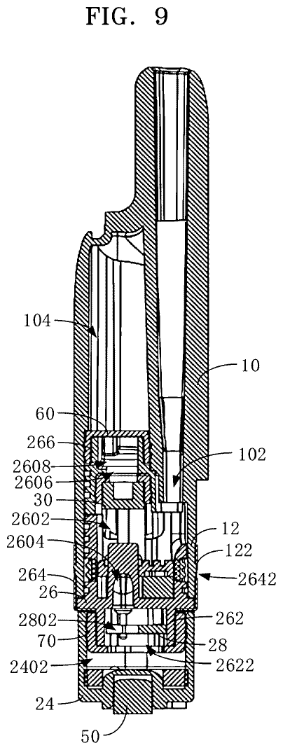

FIG. 7 is a 3-dimensional view of the aerosol generating device of FIG. 1 when the second mounting bracket and a fixing plate are connected; FIG. 8 is a 3-dimensional view of the aerosol generating device of FIG. 1 when the first mounting bracket, the second mounting bracket, and the fixing plate are connected; and FIG. 9 is a cross-sectional view of the aerosol generating device of FIG. 1 when the first mounting bracket, the second mounting bracket, and the nozzle assembly are connected.

Referring to FIGS. 7, 8, and 9, according to some embodiments, the housing assembly 20 may further include a fixing plate 28 for fixing electrodes of the heating assembly 30, and the second mounting bracket 26 may include a third protrusion 262 positioned within the air inlet chamber 2402.

The outer surface of the third protrusion 262 is in contact with the lower wall of the air inlet chamber 2402, an accommodation chamber 2622 is arranged on a surface of the third protrusion 262 facing the opposite side of the nozzle assembly 10, and the fixing plate 28 may be mounted inside the accommodation chamber 2622. A first air induction port 2802 is arranged coaxially with a second air induction port 2604, and the air inlet chamber 2402 may be communicated with the atomizing chamber 2602 sequentially through the first air induction port 2802 and the second air induction port 2604.

By the structure described above, the fixing plate 28 serves to fix the electrode of the heating assembly 30, and electrodes may be electrically connected to the power assembly 40 more easily, and thus the assembly process of the aerosol generating device 100 may be made simpler.

Also, the outer surface of the third protrusion 262 is in contact with the chamber sidewall of the air inlet chamber 2402, and thus the gap between the housing 22 and the first mounting bracket 24 is spaced apart from the air inlet chamber 2402, and the air inlet chamber 2402 may not communicate with the power mounting chamber 2204 through the gap between the housing 22 and the first mounting bracket 24.

In detail, a second sealing member 70 is disposed between the first mounting bracket 24 and the second mounting bracket 26, and the second sealing member 70 seals the gap between the first mounting bracket 24 and the second mounting bracket 26, thereby allowing the gap between the housing 22 and the first mounting bracket 24 to be separated from the accommodation chamber 2622.

According to the present embodiment, both the air inlet chamber 2402 and the accommodation chamber 2622 have shapes similar to cuboids, and, in a direction along the central axis line of the air inlet 2202, the first air induction port 2802 and the second air induction port 2604 are arranged inside the air inlet chamber 2402; the first air induction port 2802 is a semicircular-shaped opening, and the diameter of a hole of one end of the second air induction port 2604 that communicates with the first air induction port 2802 may be greater than the diameter of a hole of one end of the second air induction port 2604 that communicates with the atomizing chamber 2602.

According to other embodiments, the air inlet chamber 2402 and the accommodation chamber 2622 may have other shapes, e.g., cylindrical shapes; in a direction along the central axis line of the air inlet 2202, the first air induction port 2802 and the second air induction port 2604 may also be located on one side of the air inlet chamber 2402; the first air induction port 2802 may be a rectangular opening; and the second air induction port 2604 may have a cylindrical shape.

According to some embodiments, the heating assembly 30 is mounted on a sidewall of the atomizing chamber 2602 facing away from the power assembly 40, the intake chamber 102 is located on one side of the heating assembly 30, the second air induction port 2604 penetrates through the side wall of the atomizing chamber 2602 facing away from the power assembly 40, and the central axis line of the second air induction port 2604 may penetrate through the heating assembly 30.

Through the above-described structure, the second air induction port 2604 is directly opposite the heating assembly 30, and the intake chamber 102 is located on one side of the heating assembly 30, and thus it may be determined that the second air induction port 2604 and the intake chamber 102 are misaligned with each other.

When a liquid-phase aerosol generating material is atomized in the heating assembly 30 to form vapor and an external gas is introduced into the atomizing chamber 2602 along the second air induction port 2604, the external gas moves to the heating assembly 30 and is mixed with the vapor, and the external gas changes direction in the process of being mixed with the vapor, moves to a position where the intake chamber 102 communicates with the atomizing chamber 2602, and flows out of the nozzle assembly 10 along the intake chamber 102. Also, the external gas may be more sufficiently mixed with the vapor through the above-stated structure.

In detail, according to the present embodiment, the intake chamber 102 has a shape similar to a truncated cone, and the cross-sectional area of the intake chamber 102 may gradually increase in the direction opposite to the atomizing chamber 2602. Also, the atomizing chamber 2602 may have a shape similar to a cuboid, but is not limited thereto.

According to other embodiments, the intake chamber 102 may have a different shape, e.g., a cylindrical shape, and the atomizing chamber 2602 may also have a different shape, e.g., a cylindrical shape.

According to some embodiments, the central axis line of the microphone air passage 2406 is parallel to the central axis line of the first air guide port 2802, and the microphone air passage 2406 may be disposed to be misaligned with the first air induction port 2802.

Through the structure described above, the microphone air passage 2406 is misaligned with the first air induction port 2802, and, when the vapor inside the atomizing chamber 2602 passes through the first air induction port 2802 and flows back into the air inlet chamber 2402, the vapor may move to a position where the microphone air passage 2406 communicates with the air inlet chamber 2402, and the possibility of the vapor coming into contact with the microphone assembly 50 may be further reduced.

According to some embodiments, the second air induction port 2604 includes a thick cylindrical air passage 26042 and a thin cylindrical air passage 26044 that are communicated with each other and arranged coaxially, a cross-sectional diameter of the thick cylindrical air passage 26042 is greater than a cross-sectional diameter of the thin cylindrical air passage 26044, and the air inlet chamber 2402 may be communicated with the atomizing chamber 2602 sequentially through the first air induction port 2802, the thick cylindrical air passage 26042, and the thin cylindrical air passage 26044.

By the structure described above, the cross-sectional area of the thick cylindrical air passage 26042 is greater than the cross-sectional area of the thin cylindrical air passage 26044, and, in the process in which the external gas sequentially passes through the thick cylindrical air passage 26042 and the thin cylindrical air passage 26044, the flow rate of the external gas becomes faster, and the flow rate of the external gas when the external gas moves into the atomizing chamber 2602 becomes faster, and thus the external gas may be more sufficiently mixed with the vapor inside the atomizing chamber 2602.

In detail, a tubular structure in the shape of a truncated cone is disposed at one end of the thick cylindrical air passage 26042 toward the thin cylindrical air passage 26044, and the thin cylindrical air passage 26044 may be communicated with the tubular structure in the shape of a truncated cone.

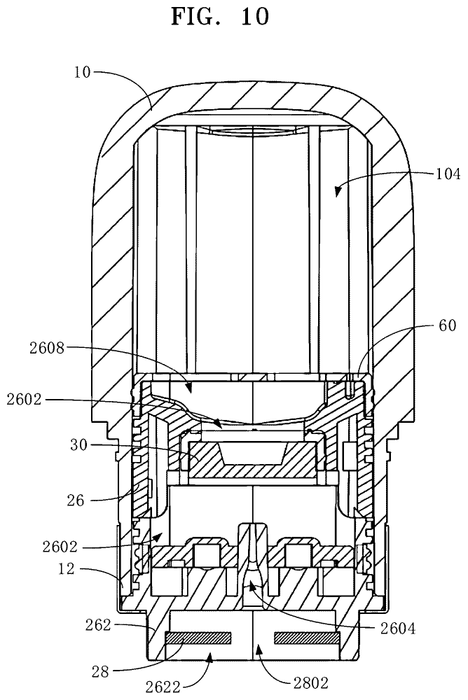

FIG. 10 is a cross-sectional view of the second bracket and the nozzle assembly of the aerosol generating device of FIG. 1 when they are connected.

Referring to FIG. 10, according to some embodiments, the aerosol generating material storage chamber 104 may be disposed on the nozzle assembly 10, the aerosol generating material storage chamber 104 may penetrate through one end of the nozzle assembly 10 facing the power assembly 40, and an aerosol generating material inlet chamber 2608 and an aerosol generating material inlet 2606 may be further arranged on the second mounting bracket 26.

The aerosol generating material inlet chamber 2608 may penetrate through one end of the second mounting bracket 26 facing away from the power assembly 40, the aerosol generating material storage chamber 104 may be communicated with the atomizing chamber 2602 sequentially through the aerosol generating material inlet chamber 2608 and the aerosol generating material inlet 2606, and the aerosol generating material storage chamber 104, the aerosol generating material inlet chamber 2608, the aerosol generating material inlet 2606, and the atomizing chamber 2602 may be sequentially arranged linearly in the direction toward the power assembly 40.

Also, the heating assembly 30 covers the aerosol generating material inlet 2606, and the nozzle assembly 10 may be arranged in a sleeve-like form on the outer surface of the second mounting bracket 26.

The first sealing member 60 is disposed between the nozzle assembly 10 and the outer surface of the second mounting bracket 26, and the first sealing member 60 may seal the gap between the nozzle assembly 10 and the outer surface of the second mounting bracket 26.

By the structure described above, after an aerosol generating material is first injected into the aerosol generating material storage chamber 104, the first sealing member 60 may be placed between the second mounting bracket 26 and the nozzle assembly 10, and the nozzle assembly 10 may be snap-connected to the second mounting bracket 26 such that the first sealing member 60 seals the gap between the outer surface of the nozzle assembly 10 and the second mounting bracket 26, thereby completing an aerosol generating material injection process. At this time, the aerosol generating material storage chamber 104 may penetrate through one end of the nozzle assembly 10 facing the power assembly 40, and, when the aerosol generating material storage chamber 104 is opened, the aerosol generating material may be more easily injected into the aerosol generating material storage chamber 104.

The aerosol generating material inlet chamber 2608 penetrates through one end of the second mounting bracket 26 facing the opposite side of the power assembly 40, the aerosol generating material storage chamber 104 communicates with the aerosol generating material inlet chamber 2608, and the aerosol generating material within the aerosol generating material storage chamber 104 may be introduced into the aerosol generating material inlet chamber 2608 through the aerosol generating material storage chamber 104.

In detail, the second mounting bracket 26 includes a sealing block 266, the aerosol generating material inlet 2606 and the aerosol generating material inlet chamber 2608 are arranged in the sealing block 266, the aerosol generating material inlet chamber 2608 may penetrate through one end of the sealing block 266 facing the opposite side of the power assembly 40, and the aerosol generating material inlet 2606 may penetrate through one end of the sealing block 266 facing the power assembly 40.

The chamber wall of the aerosol generating material storage chamber 104 is disposed in a sleeve-like form on the outer surface of the sealing block 266, the first sealing member 60 includes a silica gel material, the first sealing member 60 is positioned between the aerosol generating material storage chamber 104 and the outer surface of the sealing block 266, and the first sealing member 60 may seal the gap between the nozzle assembly 10 and the outer surface of the second mounting bracket 26.

Referring back to FIG. 2, according to some embodiments, the air inlet 2202 may include two inlets, and the air inlet 2202 including the two inlets (e.g., a first inlet and a second inlet) may be symmetrically arranged around the central axis line of the housing assembly 20.

By the structure described above, when a user puffs the aerosol generating device 100, external gas may be simultaneously introduced into the air inlet chamber 2402 by passing through the air inlet 2202 consisting of two inlets. Directions of movement of external gas entering the air inlet chamber 2402 through the air inlet 2202 consisting of two inlets is opposite to each other, the external gas may merge inside the air inlet chamber 2402, and, after the external gas merges, the external gas may move more uniformly into the atomizing chamber 2602, such that the external gas may be more sufficiently mixed with the vapor inside the atomizing chamber 2602.

In detail, according to the present embodiment, the number of inlets included in each air inlet may be one, but is not limited thereto. According to other embodiments, the number of inlets included in each air inlet may differ. For example, the number of inlets included in each air inlet may be two. In another embodiment, the number of inlets included in one air inlet may be two, and the number of inlets included in another air inlet may be three.

To conclude, the above-stated embodiments are merely for describing the technical solutions of the disclosure, and are not limited thereto; in the context of the disclosure, combinations of technical features of the above-stated embodiments or other embodiments may be implemented, operations may be implemented in any order, various modifications exist in different aspects of the disclosure as described above, and, for the sake of simplicity, the modifications may not be described in detail; referring to the detailed description of the disclosure through the above-stated embodiments, one of ordinary skill in the art may modify the technical solutions described in each of the above-stated embodiments, or equivalently replace some of the other technical features; and it will be understood that the essence of the technical solutions does not depart from the scope of the technical solutions of each embodiment of the disclosure by such modification or replacement.

1. An aerosol generating device comprising:
a nozzle assembly comprising an intake chamber arranged therein;
a housing assembly in which the nozzle assembly is disposed, the housing assembly comprising an air inlet, a power mounting chamber, an atomizing chamber and an air inlet chamber, wherein the air inlet is disposed on a side surface of the housing assembly, and communicated with the intake chamber through the air inlet chamber and the atomizing chamber, and the power mounting chamber is spaced apart from the air inlet chamber by a spacer;
a heating assembly disposed inside the atomizing chamber; and
a power assembly disposed inside the power mounting chamber and configured to supply power to the heating assembly,
wherein the power assembly, the heating assembly and the nozzle assembly are sequentially arranged in a linear sequence.

2. The aerosol generating device of claim 1, further comprising a microphone assembly,
wherein the housing assembly further comprises a microphone mounting chamber and a microphone air passage,
the microphone mounting chamber is communicated with the power mounting chamber,
the air inlet chamber is communicated with the microphone mounting chamber through the microphone air passage, and
the microphone assembly is mounted in the microphone mounting chamber and separates the microphone air passage from the power mounting chamber.

3. The aerosol generating device of claim 2, wherein the housing assembly further comprises a housing, a first mounting bracket, and a second mounting bracket,
the first mounting bracket and the second mounting bracket are sequentially mounted inside the housing in a direction from the housing toward the nozzle assembly,
the nozzle assembly is mounted on the second mounting bracket,
the air inlet chamber, the microphone mounting chamber, and the microphone air passage are arranged at the first mounting bracket,
the air inlet and the power mounting chamber are arranged in the housing, and
the atomizing chamber is disposed on the second mounting bracket.

4. The aerosol generating device of claim 3, wherein the air inlet chamber penetrates a surface of the first mounting bracket facing the nozzle assembly,
the microphone mounting chamber penetrates a surface of the first mounting bracket facing opposite to the nozzle assembly,
an airflow induction hole is located in a sidewall of the air inlet chamber, and
the air inlet is communicated with the air inlet chamber through the airflow induction hole.

5. The aerosol generating device of claim 3, wherein the first mounting bracket comprises a first protrusion and a second protrusion,
the first protrusion and the second protrusion are located inside the air inlet chamber,
the first protrusion protrudes against a lower chamber wall of the air inlet chamber,
the second protrusion protrudes against a surface of the first protrusion facing the nozzle assembly,
the microphone mounting chamber is placed on the first protrusion,
the microphone air passage penetrates the second protrusion, and
a central axis line of the air inlet is in a common plane with one end surface of the second protrusion, and positioned so as not to intersect an outer surface of the second protrusion.

6. The aerosol generating device of claim 3, wherein the housing assembly further comprises a fixing plate,
the fixing plate fixes electrodes of the heating assembly,
the second mounting bracket comprises a third protrusion,
the third protrusion is positioned inside the air inlet chamber, and an outer surface of the third protrusion is in contact with a chamber sidewall of the air inlet chamber,
an accommodation chamber is disposed on a surface of the third projection facing opposite to the nozzle assembly, and
the fixing plate is placed inside the accommodation chamber.

7. The aerosol generating device of claim 6, wherein a first air induction port is disposed on the fixing plate,
a second air induction port is disposed at the second mounting bracket,
the first air induction port and the second air induction port are arranged coaxially, and the air inlet chamber communicates with the atomizing chamber through the first air induction port and the second air induction port.

8. The aerosol generating device of claim 7, wherein the heating assembly is mounted on a wall of the atomizing chamber opposite the power assembly, the intake chamber is located on one side of the heating assembly, the second air induction port penetrates through the atomizing chamber and faces a wall of the power assembly, and a central axis line of the second air induction port penetrates the heating assembly.

9. The aerosol generating device of claim 7, wherein a central axis line of the microphone air passage is parallel to a central axis line of the first air induction port, and the microphone air passage is misaligned with the first air induction port.

10. The aerosol generating device of claim 7, wherein the second air induction port comprises a thick cylindrical air passage and a thin cylindrical air passage which are communicated with each other and arranged coaxially,
a cross-sectional diameter of the thick cylindrical air passage is greater than a cross-sectional diameter of the thin cylindrical air passage, and
the air inlet chamber communicates with the atomizing chamber through the first air induction port, the thick cylindrical air passage, and the thin cylindrical air passage.

11. The aerosol generating device of claim 3, wherein an aerosol generating material storage chamber is disposed in the nozzle assembly,
the aerosol generating material storage chamber penetrates the nozzle assembly and is directed toward one end of the power assembly,
an aerosol generating material inlet chamber and an aerosol generating material inlet are further arranged on the second mounting bracket,
the aerosol generating material inlet chamber penetrates one end of the second mounting bracket opposite to the power assembly,
the aerosol generating material storage chamber sequentially passes through the aerosol generating material inlet chamber, and the aerosol generating material inlet and communicates with the atomizing chamber,
the aerosol generating material storage chamber, the aerosol generating material inlet chamber, the aerosol generating material inlet, and the atomizing chamber are arranged linearly and sequentially in a direction toward the power assembly,
the heating assembly covers the aerosol generating material inlet, and
the nozzle assembly is disposed on an outer surface of the second mounting bracket.

12. The aerosol generating device of claim 11, wherein a first sealing member is disposed between an outer surface of the nozzle assembly and the second mounting bracket, and
the first sealing member seals a gap between the nozzle assembly and the outer surface of the second mounting bracket.

13. The aerosol generating device of claim 1, wherein the air inlet comprises two inlets symmetrically arranged with respect to the central axis line of the housing assembly.
